(19) United States
(12) Patent Application Publication
(10) Pub. No.: US 2016/0037731 A1
(43) Pub. Date: Feb. 11, 2016

(54) PLANT CULTIVATION APPARATUS

(71) Applicant: Ming-Tsun Lin, Hsinchu County (TW)

(72) Inventor: Ming-Tsun Lin, Hsinchu County (TW)

(21) Appl. No.: 14/451,644

(22) Filed: Aug. 5, 2014

(51) Int. Cl. A01G 9/02

(52) U.S. Cl. CPC A01G 9/02

(57) ABSTRACT

A plant cultivation apparatus includes at least one container body, an elongated bottom plate installed at the container body, plural grids formed and separated by a partition, a rear plate installed on a side of the bottom plate and coupled between the partitions, a window formed on the rear plate and interconnected to each grid, and a first through hole formed on the bottom plate and interconnected to each respective grid. Each grid serves as a growth space for accommodating a plant, and the first through hole serves as a channel of a cultivation liquid in contact with the root of the plant and the bottom of the container body, such that the growing space of each plant obtains good air convection to improve the growing quality of the plant.

### FIELD OF THE INVENTION

The present invention relates to a plant cultivation apparatus, in particular to the plant cultivation apparatus that arranges a plurality of plants in predetermined partitions for cultivation and provides a better air convection effect for the growing space of each plant, so as to improve the growing quality of the plants.

### BACKGROUND OF THE INVENTION

To prevent wasting too much time and cost on seed cultivation in the agriculture industry and assuring the quality and yield rate of cultivating seeds into seedlings, a seedling of an agricultural product grown to a specific level is generally used for the cultivation to improve the survival rate of the agricultural product, wherein plug seedling cultivation technology has the advantages and features of saving seeds, growing the seedlings consistently, reducing pets and diseases, and providing a high transplant survival rate and an early picking period to facilitate the development of the seedling production automation.

In addition, the structural design of a plug tray in compliance with the practical application affects the production capacity and cost of the plant seedling operation directly. A conventional plug tray generally includes a plurality of grids arranged with a fixed interval apart from one another on a tray, and each grid comes with a predetermined width and a predetermined depth recessed into the tray.

During use, the seedling to be cultivated is planted into a soft tray containing a medium (such as culture soil, rock wool, sponge, vermiculite, coconut fiber or refining stone), and then a soft tray containing the medium and the seedlings are placed into the grids of the plug tray for the cultivation.

Most of the conventional plug trays available in the market and having a relatively higher seedling cultivation rate arrange the grids in a matrix form and according to the growth of the seedlings to the distance capable of setting the grids for the growth scale of the transplant. However, such structural design has a very large limitation to the air flow between the seedlings, since the growing space of the seedlings cannot obtain the required air convection effect. As a result, the seedlings may be decayed easily by the too-wet condition in the growing space.

### SUMMARY OF THE INVENTION

In view of the aforementioned problems of the prior art, it is a primary objective of the present invention to provide a plant cultivation apparatus that arranges a plurality of plants to be cultivated in predetermined grids, and allows the growing space of each plant to have a better air convection effect, so as to improve the quality of growing the plants.

Therefore, it is a primary objective of the present invention to provide a plant cultivation apparatus, comprising: at least one container body, an elongated bottom plate installed at the container body, a plurality of grids formed and separated by a partition, a rear plate installed on a side of the bottom plate and coupled between the partitions, a window formed on the rear plate and interconnected to each grid, and a first through hole formed on the bottom plate and interconnected to each respective grid.

In an application of the plant cultivation apparatus of the present invention with the aforementioned structural characteristics, each grid of the container body serves as a growing space for accommodating a plant, and the first through hole formed on the bottom plate serves as a channel of a cultivation liquid in contact with the root of the plant and the bottom of the container body, such that the growing space of each plant obtains good air convection to improve the growing quality of the plant.

Specifically, the plant cultivation apparatus of the present invention not just provides a good air convection effect for the growing space of each plant under the effect of the window of the container body to prevent the growing space from being too wet and decaying the plants by a positive and reliable measure, so as to improve the growing quality of the plants , but also provides a modular plant cultivation apparatus operated with the chassis to achieve the effects of increasing the plant cultivation density and facilitating the management of the plant cultivation effectively. Further, the medium carrying frame is provided for the seedling cultivation of the plant, and the medium carrying frame together with the cultivated seedlings are transplanted into the container body for the growth of the plant, so as to provide a consistently oriented plant cultivation operation to reduce the labor cost and the breakage rate of the plant transplantation and cultivation.

### BRIEF DESCRIPTION OF THE DRAWINGS

FIG. 1 is a perspective view of a container body in accordance with a first preferred embodiment of the present invention;

FIG. 2 is an exploded view of a container body and a chassis in accordance with a second preferred embodiment of the present invention;

FIG. 3 is an exploded view of a container body and a medium carrying frame in accordance with a third preferred embodiment of the present invention;

FIG. 4 is a schematic view of a using status of a container body, a medium carrying frame and a chassis in accordance with a fourth preferred embodiment of the present invention;

FIG. 5 is a sectional view of a using status of a container body, a medium carrying frame and a chassis in accordance with the fourth preferred embodiment of the present invention; and

FIG. 6 is a perspective view of a container body of another preferred embodiment of the present invention.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

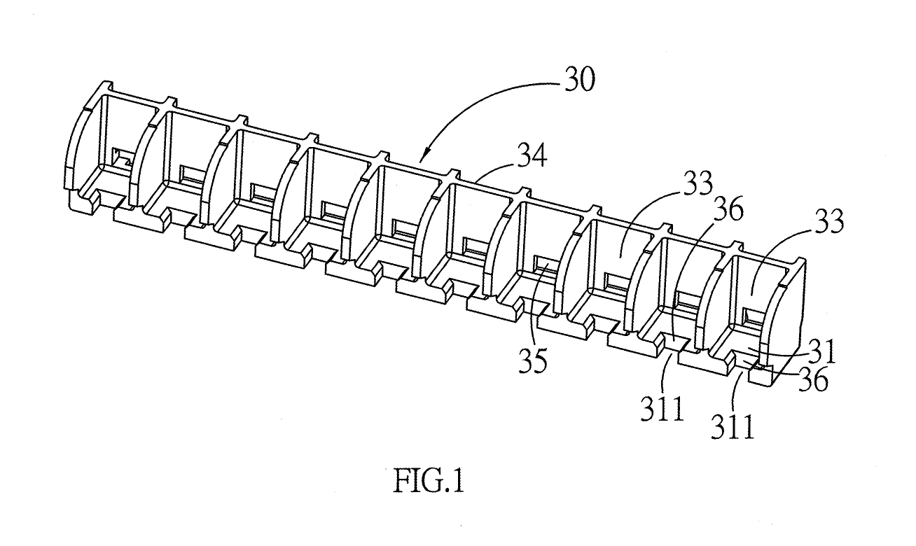

The present invention provides a plant cultivation apparatus capable of arranging a plurality of plants to be cultivated into predetermined grids and allowing the growing space of each plant to have a good air convection effect, so as to improve the growing quality of the plant. The plant cultivation apparatus of the present invention as shown in FIG. 1 comprises at least one container body 30, an elongated bottom plate 31 installed at the at least one container body 30, a plurality of equidistant partitions 32 installed on the bottom plate 31 to divide the bottom plate 31 into a plurality of grids 33, a rear plate 34 installed at one side of the bottom plate 31 and coupled between the partitions 32, a plurality of windows 35 formed on the rear plate 34 and interconnected to the grids 33 respectively, and a plurality of first through holes 36 formed on the bottom plate 31 and interconnected to the grids 33 respectively.

In an application of the plant cultivation apparatus of the present invention, each grid 33 of the container body 30 serves as the growing space of a plant 10, and the first through hole 36 of the bottom plate 31 serves as a channel of a cultivation liquid in contact with the root of the plant 10 and the bottom of the container body 30. Specifically, the growing space of each plant 10 has a good air convection under the effect of the window 35 of the container body 30, and the invention prevents the growing space from being too wet and decaying the plant by a positive and reliable measure, so as to improve the growing quality of the plant 10.

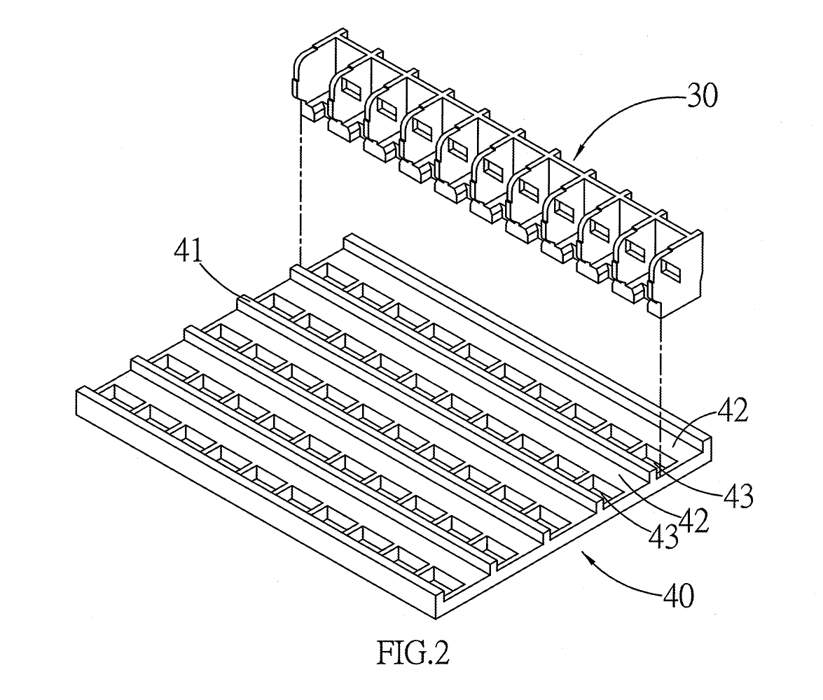

The plant cultivation apparatus of the present invention as shown in FIG. 2 further comprises a chassis 40, and the chassis 40 includes a plurality of slots 42 for installing and fixing the container bodies 30 respectively. During an implementation, the slot 42 of the chassis 40 is formed by separating a plurality of ribs 41 parallelly protruded form the top of the chassis 40, and the chassis 40 includes a plurality of second through holes 43 formed at the slots 42 and aligned precisely and respectively with the first through holes 36 of the container body 30, so as to form the channel of a cultivation liquid in contact with the root of the plant and the bottom of the chassis 40.

In an application of the plant cultivation apparatus of the present invention with the chassis 40, the container bodies 30 are installed on the chassis 40, so that the cultivated plants are arranged in a matrix form to form a modular plant cultivation apparatus, so as to improve the cultivation density of the plant 10 and facilitate the cultivation management of the plant 10.

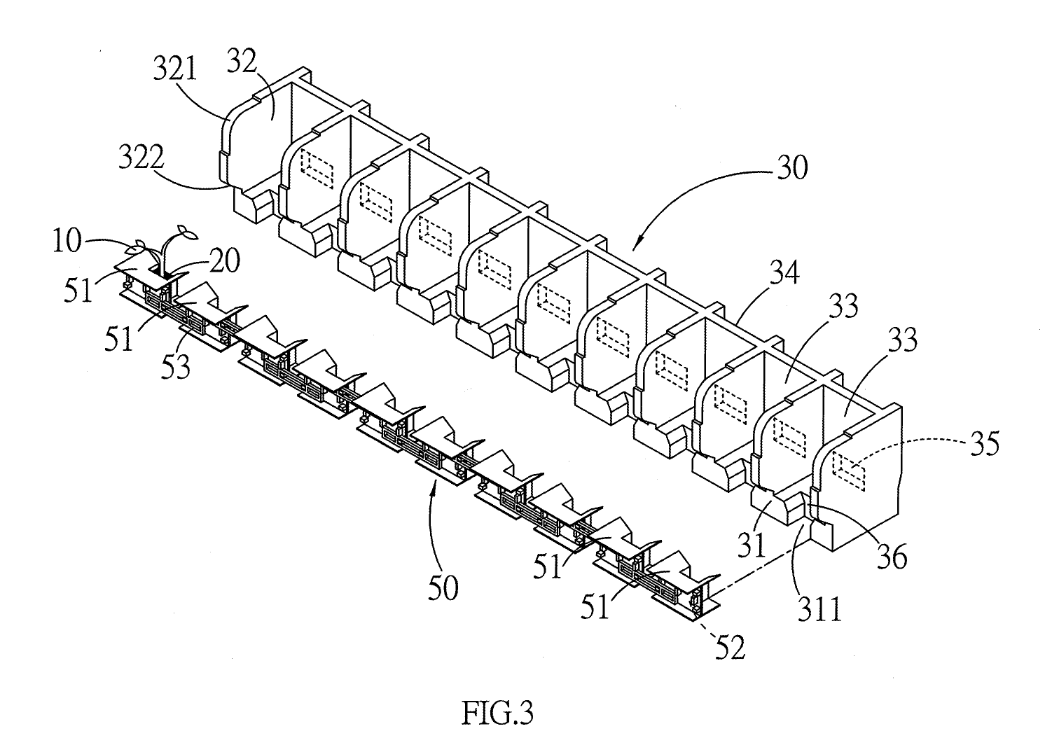

In FIG. 3, the plant cultivation apparatus of the present invention further comprises at least one medium carrying frame 50 installed on the other side of the rear plate 34 of the at least one container body 30, and the at least one medium carrying frame 50 includes a plurality of container units 51 coupled to the medium carrying frames 50 and extended into the grids 33 respectively, wherein the container unit 51 serves as the space for containing the medium and the plant seedlings, and the at least one medium carrying frame 50 includes a third through hole 52 formed at the bottom of each container unit 51 and aligned precisely with the first through hole 36, so as to form a channel of a cultivation liquid in contact with the root of the plant and the bottom of the container body 30.

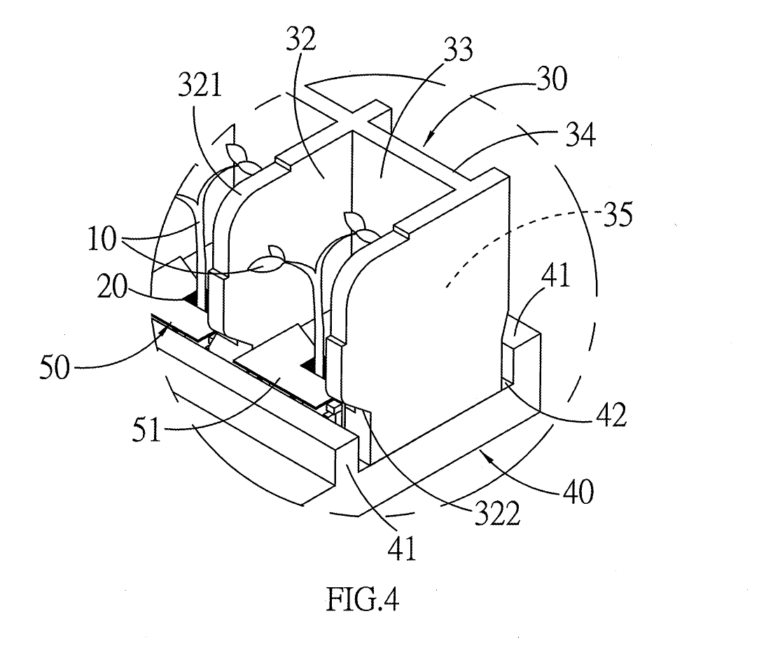

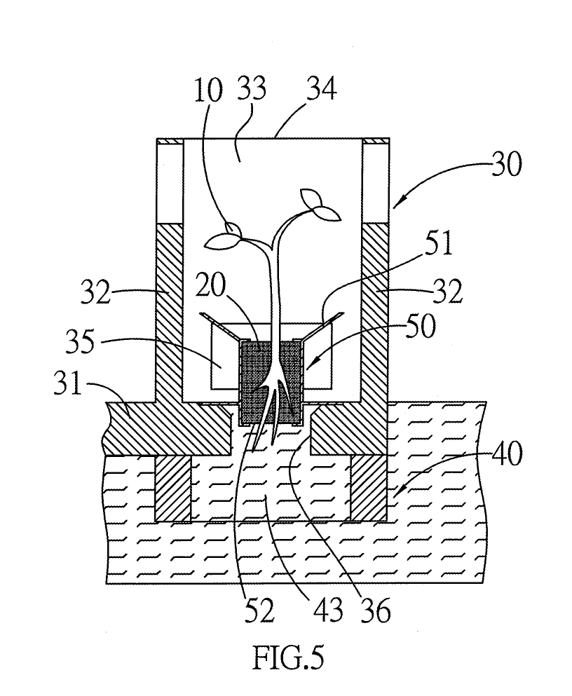

With reference to FIGS. 4 and 5 for a plant cultivation apparatus in according to different preferred embodiments of the present invention, the plant cultivation apparatus preferably further comprises a chassis 40, and at least one medium carrying frame 50. Similarly, the chassis 40 includes a plurality of slots 42 for installing and fixing the container bodies 30 respectively, and the chassis 40 includes a plurality of second through holes 43 formed in the slots 42 and aligned precisely and respectively with the first through holes 36 of the container body 30.

The at least one medium carrying frame 50 is installed on the other side of the rear plate 34 of the at least one container body 30 and coupled to a plurality of container units 51 extended into the grids 33 respectively, and the container unit 51 serves as a space for containing the medium 20 and the seedling of the plant 10, and the at least one medium carrying frame 50 includes a third through hole 52 formed at the bottom of each container unit 51 and aligned precisely with the first through hole 36.

The medium carrying frame 50 is provided for cultivating the seedlings of the plant, and then the medium carrying frame 50 together with the cultivated seedlings are transplanted and grown in the container body 30, and the consistently oriented plant cultivation operation is provided for reducing the labor cost and breakage rate of cultivating and transplanting the plant 10.

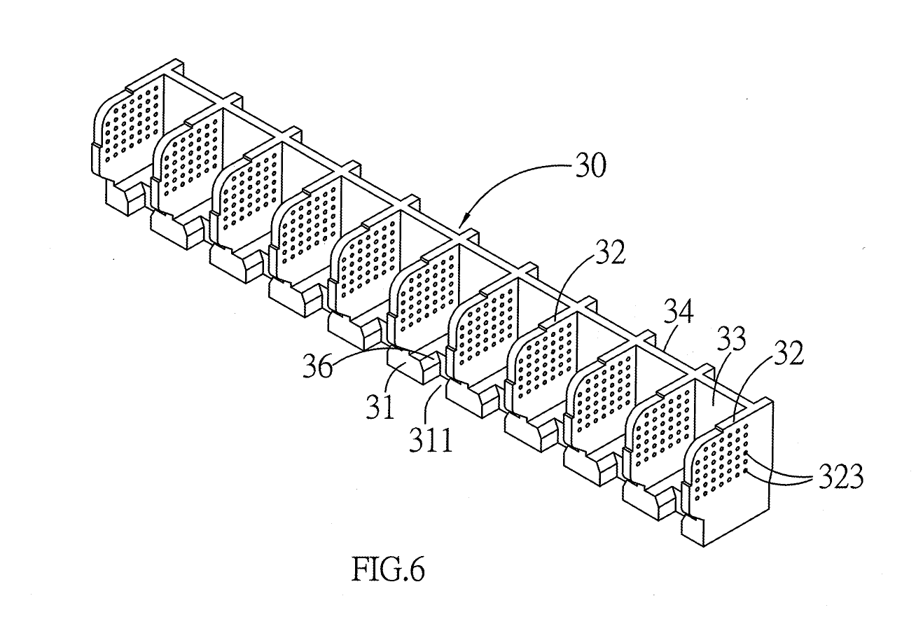

In the aforementioned preferred embodiments of the plant cultivation apparatus of the present invention, the at least one container body 30 includes a curved guide corner 321 formed at the top of the other side of each partition 32 coupled to the rear plate 34, or the at least one container body 30 includes an inwardly inclined chamfered surface 322 disposed at the bottom of the other side of each partition 32 coupled to the rear plate 34, or the at least one container body 30 as shown in FIG. 6 includes a plurality of penetrating holes 323 formed on each partition 32 in order to achieve the effect of improving the air convection effect.

Preferably, the overall container body 30 includes a curved guide corner 321 formed at the top of the other side of each partition 32 coupled to the rear plate 34, an inwardly inclined chamfered surface 322 formed at the bottom of the other side of each partition 32 coupled to the rear plate 34, and a plurality of penetrating holes 323 formed on each partition 32.

With reference to FIGS. 3 to 5 for a plant cultivation apparatus of the present invention with at least one medium carrying frame 50 in accordance with different embodiments, the at least one container body 30 preferably includes a plurality of notches 311 formed on the other side of the bottom plate 31 having the rear plate 34 and interconnected to the first through holes 36 respectively, so that the assembling process of the medium carrying frame 50 and the container body 30 will not be affected under the condition that the root of the plant 10 has passed out from the third through hole 52 of the medium carrying frame 50.

In addition, the at least one medium carrying frame 50 is comprised of a plurality of container units 51 and a plurality of connecting plates 53 coupled between the adjacent container units 51, so that the variability and applicability of the application of the medium carrying frame 50 are improved, and the other side of each container unit 51 coupled to the connecting plate 53 is preferably in an open form in order to further improve the air convection effect of the growing space of the plant.

Compared with the prior art, the plant cultivation apparatus of the present invention not just provides a good air convection effect for the growing space of each plant under the effect of the window of the container body to prevent the growing space from being too wet and decaying the plants by a positive and reliable measure, so as to improve the growing quality of the plants , but also provides a modular plant cultivation apparatus operated with the chassis to achieve the effects of increasing the plant cultivation density and facilitating the management of the plant cultivation effectively. Further, the medium carrying frame is provided for the seedling cultivation of the plant, and the medium carrying frame together with the cultivated seedlings are transplanted into the container body for the growth of the plant, so as to provide a consistently oriented plant cultivation operation to reduce the labor cost and the breakage rate of the plant transplantation and cultivation.

In summation of the description above, the present invention achieves the aforementioned functions and objectives and complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A plant cultivation apparatus, comprising:
at least one container body, having an elongated bottom plate;
a plurality of equidistant partitions, installed on the bottom plate, such that the bottom plate is divided into a plurality of grids;
a rear plate, installed on one of the sides of the bottom plate, and coupled between the partitions;
a window, formed on the rear plate, and interconnected to each grid; and
a first through hole, formed on the bottom plate, and interconnected to each respective grid.

2. The plant cultivation apparatus of claim 1, further comprising:
a chassis, having a plurality of slots, for installing and fixing the container bodies respectively; and
a plurality of second through holes, formed in the slots of the chassis, and aligned respectively and precisely with the first through holes of the container body.

3. The plant cultivation apparatus of claim 2, wherein the slot of the chassis is formed by separating a plurality of ribs parallelly protruded from the top of the chassis.

4. The plant cultivation apparatus of claim 1, further comprising:
at least one medium carrying frame, installed to the other side of the rear plate of the at least one container body;
a plurality of container units, coupled to the at least one medium carrying frame, and extended into the grids respectively; and
a third through hole, formed at the at least one medium carrying frame and each container unit, and aligned precisely with the first through hole.

5. The plant cultivation apparatus of claim 4, wherein the at least one container body includes a plurality of notches formed on the bottom plate and opposite to the other side having the rear plate and interconnected to the first through holes respectively.

6. The plant cultivation apparatus of claim 4, wherein the at least one medium carrying frame is comprised of a plurality of container units and a plurality of connecting plates coupled and installed between adjacent container units.

7. The plant cultivation apparatus of claim 4, wherein the other side of each container unit provided for coupling the connecting plate is in an open form.

8. The plant cultivation apparatus of claim 1, further comprising:
a chassis, having a plurality of slots for installing and fixing a plurality of container bodies, and a plurality of second through holes formed in the slots for containing the container bodies and aligned precisely with the second through holes respectively; and
at least one medium carrying frame, installed on the other side of the rear plate of the at least one container body, and having a plurality of container units coupled to the medium carrying frame and extended into each grid, and a third through hole formed at the bottom of each container unit and aligned precisely with the first through hole.

9. The plant cultivation apparatus of claim 8, wherein the slot of the chassis is formed by separating a plurality of ribs parallelly protruded from the top of the chassis.

10. The plant cultivation apparatus of claim 8, wherein the at least one container body includes a plurality of notches formed on the other side of the bottom plate opposite to the rear plate and interconnected to the first through holes respectively.

11. The plant cultivation apparatus of claim 8, wherein the at least one medium carrying frame is formed by assembling a plurality of container units and a plurality of connecting plates coupled between the adjacent container units.

12. The plant cultivation apparatus of claim 8, wherein the other side of each container unit coupled to the connecting plate is substantially in an open form.

13. The plant cultivation apparatus of claim 1, wherein the at least one container body includes a curved guide corner disposed on the other side of each partition coupled to the rear plate.

14. The plant cultivation apparatus of claim 1, wherein the at least one container body includes an inwardly inclined chamfered surface disposed at the bottom of the other side of each partition coupled to the rear plate.

15. The plant cultivation apparatus of claim 1, wherein the at least one container body includes a plurality of penetrating holes formed on each partition.

16. The plant cultivation apparatus of claim 1, wherein the at least one container body includes a curved guide corner formed at the top of the other side of each partition coupled to the rear plate, an inwardly inclined chamfered surface disposed on the other side of each partition coupled to the rear plate, and a plurality of penetrating holes formed on each partition.
